(19) United States
(12) Patent Application Publication
(10) Pub. No.: US 2003/0225236 A1
(43) Pub. Date: Dec. 4, 2003

(54) Preparation of organopolysiloxane

(76) Inventors: Masaharu Takahashi, Annaka-shi (JP); Yutaka Hagiwara, Annaka-shi (JP); Tomohiko Suto, Annaka-shi (JP)

Correspondence Address: BIRCH STEWART KOLASCH & BIRCH, PO BOX 747, FALLS CHURCH, VA, 22040-0747, US

(21) Appl. No.: 10/449,771

(22) Filed: Jun. 3, 2003

(30) Foreign Application Priority Data
Jun. 3, 2002 (JP) 2002-161377
Jun. 3, 2002 (JP) 2002-161380

(51) Int. Cl. C08G 77/06

(52) U.S. Cl. 528/12; 528/21; 528/23

(57) ABSTRACT

An organopolysiloxane terminated with silanol at both ends is prepared by polymerizing a siloxane having silanol at both ends in the presence of a thermally decomposable polymerization catalyst and under a reduced pressure below atmospheric pressure.

### TITLE OF THE INVENTION

### Preparation of Organopolysiloxane

This invention relates to a method for preparing an organopolysiloxane suitable for use in various silicone rubber compositions, using a silanol-terminated siloxane as the main reactant.

### BACKGROUND OF THE INVENTION

One known method for the preparation of organopolysiloxane polymers involves hydrolyzing a chlorosilane, subjecting the resulting hydrolyzate, siloxane having silanol at both ends to alkali cracking and distillation, polymerizing the resulting cyclic organosiloxane in the presence of an alkali catalyst, neutralizing the catalyst for deactivation, and distilling off a low volatile fraction from the product. The method requires the alkali cracking and distillation steps in order to form the cyclic organosiloxane, undesirably increasing the number of steps and the cost. The process would be desirably simplified if an organopolysiloxane can be prepared directly from a siloxane having silanol at both ends.

In the preparation of organopolysiloxanes, alkali catalysts are generally used as the polymerization catalyst. Catalysts of a particular type must be neutralized with acidic neutralizing agents such as acetic acid, phosphoric acid, ethylene chlorohydrin and carbon dioxide. The neutralizing step has the problem that if the neutralizing agent is short, part of the alkali catalyst is left behind, and if the neutralizing agent is excessive, it is left behind. In either case, the resulting organopolysiloxane has varying thermal stability. In order to eliminate the neutralizing step, it is desirable to use thermally decomposable polymerization catalysts. For instance, when the dimethylpolysiloxanate of tetra-n-butylphosphonium hydroxide is used as the catalyst, the residual catalyst can be deactivated by heating at 130 to 150° C.

Also in the preparation of organopolysiloxanes, even when an end-capping agent is used for capping the end with a triorganosilyl group, trace moisture entrained in the reactant can also act as an end-capping agent. This results in an organopolysiloxane having hydroxyl groups (silanol groups) incorporated in terminal units, as opposed to the desired terminal units. The high molecular weight organopolysiloxane having terminal hydroxyl groups (silanol groups) thus formed, when formulated to a silicone rubber compound, can cause the compound to develop a crepe hardening phenomenon with the passage of time. On use, the crepe hardened compound must be restored to the initial state by applying strong shear again.

It is thus needed to remove trace moisture from cyclic organosiloxanes and low molecular weight linear organopolysiloxanes used as the main reactant. This is done, for example, by blowing an inert gas such as nitrogen and holding at a temperature of at least 100° C.

Meanwhile, polymerization under reduced pressure is known as a simple process for efficiently preparing an organopolysiloxane having a low hydroxyl group content in terminal units. In conjunction with the preparation of an organopolysiloxane by polymerizing a cyclic organosiloxane with a low molecular weight linear organopolysiloxane end-capped with a triorganosilyl group in the presence of an alkaline catalyst, it has already been established that an organopolysiloxane containing few hydroxyl groups in terminal units is prepared by effecting the polymerization reaction under a reduced pressure below atmospheric pressure.

### SUMMARY OF THE INVENTION

A first object of the invention is to provide an efficient method for preparing an organopolysiloxane having silanol at both ends.

A second object of the invention is to provide a method for preparing an organopolysiloxane, using a siloxane having silanol at both ends, which is conventionally believed disadvantageous in producing an organopolysiloxane having less terminal hydroxyl groups, as the main reactant in the presence of a thermally decomposable polymerization catalyst. This method is to produce a triorganosilyl group end-capped organopolysiloxane which is substantially free of a silanol group-bearing organopolysiloxane.

It has been found that when an organopolysiloxane is prepared by polymerizing a siloxane having silanol at both ends as the main reactant, the use of a thermally decomposable catalyst as the polymerization catalyst, combined with the polymerization reaction effected under a reduced pressure below atmospheric pressure, preferably 100 mmHg or lower, is successful in producing an organopolysiloxane capped with a silanol group at both ends through a simple step and in an industrial advantageous manner without problems like equipment corrosion.

It has also been found that when an organopolysiloxane is prepared by polymerizing a siloxane having silanol at both ends as the main reactant with a triorganosilyl end-capped linear organosiloxane, the use of a thermally decomposable catalyst as the polymerization catalyst, combined with the polymerization reaction effected under a reduced pressure below atmospheric pressure, preferably 100 mmHg or lower, is successful in producing a triorganosilyl group end-capped organopolysiloxane, which is substantially free of a hydroxyl (silanol) group end-capped organopolysiloxane, through a simple step and in an industrial advantageous manner without problems like equipment corrosion. The organopolysiloxane obtained by this method can be advantageously used as one component for a wide variety of silicone rubber compositions because a silicone rubber composition formulated by compounding the organopolysiloxane together with reinforcements like silica does give rise to little or no crepe hardening phenomenon.

Accordingly, in a first aspect, the present invention provides a method for preparing an organopolysiloxane terminated with silanol at both ends by polymerizing a siloxane having silanol at both ends in the presence of a thermally decomposable polymerization catalyst and under a reduced pressure below atmospheric pressure.

In a second aspect, the method for preparing an organopolysiloxane according to the invention involves the step of polymerizing a siloxane having silanol at both ends with a triorganosilyl end-capped linear organosiloxane in the presence of a thermally decomposable polymerization catalyst under a reduced pressure below atmospheric pressure to produce a triorganosilyl group end-capped organopolysiloxane.

### DESCRIPTION OF THE PREFERRED EMBODIMENTS

In the method according to the first embodiment of the invention, an organopolysiloxane capped with silanol at both ends, typically having a degree of polymerization of at least 500 is prepared by effecting polymerization of a siloxane having silanol at both ends in the presence of a thermally decomposable catalyst and under a reduced pressure below atmospheric pressure, typically 100 mmHg or lower.

The siloxane having silanol at both ends (simply referred to as silanol-terminated siloxane) used as the main reactant preferably has the following formula (1).

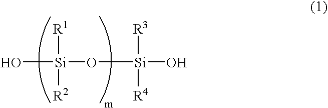

In formula (1), R¹ to R⁴ which may be the same or different, each independently stand for substituted or unsubstituted monovalent hydrocarbon groups, and m is an integer of 2 to 2,000, preferably 5 to 1,000, more preferably 10 to 500. Preferably R¹ to R⁴ are substituted or unsubstituted monovalent hydrocarbon groups having 1 to 12 carbon atoms, especially 1 to 10 carbon atoms, for example, alkyl groups such as methyl, alkenyl groups such as vinyl, and aryl groups such as phenyl. Of these, methyl, vinyl and phenyl are most preferred.

In the practice of the invention, a cyclic organopolysiloxane may be added to the silanol-terminated siloxane.

Suitable thermally decomposable polymerization catalysts include quaternary phosphonium compounds such as (n-C₄H₉)₄POH, quaternary ammonium compounds such as (CH₃)₄NOH, and silanolates thereof. These polymerization catalysts can be deactivated through thermal decomposition. The preferred catalysts are tetra-n-butylphosphonium hydroxide and tetramethylammonium hydroxide as well as dimethylpolysiloxanates thereof.

The thermally decomposable polymerization catalyst is used in a catalytic amount. When tetra-n-butylphosphonium hydroxide is used as the polymerization catalyst, the preferred amount added is 0.001 to 0.1 part by weight, especially 0.001 to 0.05 part by weight per 100 parts by weight of the silanol-terminated siloxane.

In the inventive method, the polymerization reaction is effected under a reduced pressure below atmospheric pressure (760 mmHg), whereby the water formed by polycondensation reaction of the silanol-terminated siloxane can be effectively removed. The polymerization temperature is preferably at least 80° C., more preferably 80 to 130° C., most preferably 100 to 110° C., and the reduced pressure is preferably 100 mmHg or lower, more preferably 50 mmHg or lower. If the pressure is equal to or above atmospheric pressure, it becomes difficult to remove the water formed to a sufficient level for polycondensation to proceed, failing to achieve the objects of the invention.

After the completion of polymerization reaction, the system is preferably heated to a temperature equal to or above the decomposition temperature of the thermally decomposable polymerization catalyst, especially 130 to 180° C. for thereby deactivating the residual catalyst through thermal decomposition. After the deactivation of the catalyst, a low volatile fraction is preferably removed as by stripping.

The method according to the first embodiment of the invention yields an organopolysiloxane having a degree of polymerization of at least 500, especially at least 5,000. No upper limit need be imposed on the degree of polymerization.

In the method according to the second embodiment of the invention, an organopolysiloxane, especially a gum-like organopolysiloxane is prepared by polymerizing a siloxane having silanol at both ends with a triorganosilyl end-capped linear organosiloxane in the presence of a thermally decomposable catalyst and under a reduced pressure below atmospheric pressure, preferably 100 mmHg or lower.

The silanol-terminated siloxane used as the main reactant is preferably one having the formula (1) as in the first embodiment. A cyclic organopolysiloxane may be added to the silanol-terminated siloxane.

The linear organosiloxane serves as an end-capping agent to vary the degree of polymerization of the resulting organopolysiloxane. Preferred is a linear organosiloxane end-capped with a triorganosilyl group as represented by the following formula (2).

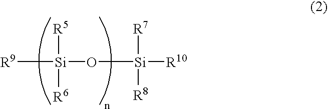

In formula (2), R⁵ to R¹⁰ which may be the same or different, each independently stand for substituted or unsubstituted monovalent hydrocarbon groups, and n is an integer of 1 to 2,000, preferably 2 to 1,000, more preferably 5 to 800. Preferably R⁵ to R⁸ are monovalent hydrocarbon groups having 1 to 12 carbon atoms, especially alkyl groups such as methyl. Also preferably R⁹ and R¹⁰ are alkyl and alkenyl groups having 1 to 5 carbon atoms, especially methyl and vinyl.

Preferred end-capping groups are shown below.

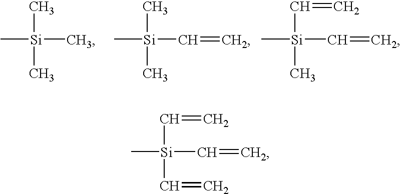

The amount of linear organosiloxane of formula (2) used is determined as appropriate in accordance with the desired degree of polymerization of the organopolysiloxane and the degree of polymerization of the linear organosiloxane itself, and preferably 0.1 to 10 parts by weight, especially 1 to 5 parts by weight per 100 parts by weight of the silanol-terminated siloxane.

The thermally decomposable polymerization catalyst used herein is of the same type and added in the same amount as described in the first embodiment.

The polymerization reaction in the method of the second embodiment can be effected at a temperature and under a reduced pressure, both in the same ranges as described in the first embodiment. If the pressure is equal to or above atmospheric pressure, it becomes difficult to remove the water formed to a full extent, allowing hydroxyl groups to survive in terminal units and thus failing to achieve the objects of the invention.

The method according to the second embodiment of the invention yields an organopolysiloxane end-capped with triorganosilyl groups, preferably a gum-like organopolysiloxane typically having a degree of polymerization of at least 3,000. No upper limit need be imposed on the degree of polymerization although the degree of polymerization is usually up to about 20,000.

The organopolysiloxane thus produced is end-capped with the triorganosilyl groups (—SiR⁵R⁶R⁹ or —SiR⁷R⁸R¹⁰ in formula (2)) of the linear organopolysiloxane as the end capping agent and is substantially devoid of a silanol-terminated organopolysiloxane. It typically has a relative viscosity of 1.05 or less as measured by the method to be described later.

### EXAMPLE

Examples of the invention are given below by way of illustration and not by way of limitation.

### Example 1

A 4-liter stainless steel reactor equipped with a motor-driven agitator of a sufficient power to agitate a high viscosity fluid having an agitating element was charged with 1,800 g of a dimethylsiloxane having silanol at both ends represented by the formula (3):

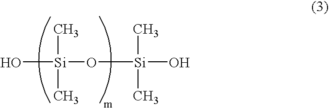

wherein m is 10 to 30, and heated to 105° C. over about one hour. After the temperature of 105° C. was reached, the reactor was held for one hour. Then, 2.8 g of a dimethylpolysiloxanate containing 10% tetra-n-butyl-phosphonium hydroxide as the thermally decomposable catalyst was added to the reactor, which was kept at the temperature of 105° C. and under a pressure of 100 mmHg for polymerization reaction to take place. After it was confirmed that the contents became polymerized to a high molecular weight, the pressure in the reactor was lowered below 3 mmHg, at which the reactor was held for 30 minutes. Thereafter, the reactor which was kept under a pressure of 100 mmHg was heated to 150° C. over about one hour and held at 150-160° C. for 30 minutes to thermally decompose the tetra-n-butylphosphonium hydroxide. Thereafter, with the pressure in the reactor lowered below 3 mmHg, a low volatile fraction was distilled off over about one hour.

During the process, the viscosity increased with the passage of polymerization time. The organopolysiloxane obtained after one hour of polymerization was a colorless clear oily product. After the polymerization proceeded further, the organopolysiloxane obtained after two hours of polymerization was a colorless clear gum-like product having an average degree of polymerization of more than 5,000 (as analyzed by GPC).

### Example 2

A 4-liter stainless steel reactor as used in Example 1 was charged with 1,730 g of a mixture of a silanol-terminated dimethylsiloxane represented by the formula (3) wherein m is 10 to 30 and a cyclic organosiloxane represented by the formula (4):

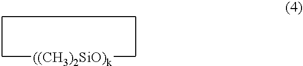

wherein k is 3 to 6 in a weight ratio of 65:35, and heated to 105° C. over about one hour. After the temperature of 105° C. was reached, the reactor was held for one hour. Then, 2.8 g of a dimethylpolysiloxanate containing 10% tetra-n-butyl-phosphonium hydroxide as the thermally decomposable catalyst was added to the reactor, which was kept at the temperature of 105° C. and under a pressure of 100 mmHg for polymerization reaction to take place. After it was confirmed that the contents became polymerized to a high molecular weight, the pressure in the reactor was lowered below 3 mmHg, at which the reactor was held for 30 minutes. Thereafter, the reactor which was kept under a pressure of 100 mmHg was heated to 150° C. over about one hour and held at 150-160° C. for 30 minutes to thermally decompose the tetra-n-butylphosphonium hydroxide. Thereafter, with the pressure in the reactor lowered below 3 mmHg, a low volatile fraction was distilled off over about one hour.

As in Example 1, the organopolysiloxane thus obtained was a colorless clear gum-like product having an average degree of polymerization of more than 5,000 (as analyzed by GPC).

### Comparative Example 1

A polymerization run was carried out as in Example 1 except that polymerization reaction was effected under atmospheric pressure.

The organopolysiloxane obtained was a colorless clear oily product having an average degree of polymerization of about 1,000 even after two hours of polymerization.

### Example 3

A 4-liter stainless steel reactor equipped with a motor-driven agitator of a sufficient power to agitate a high viscosity fluid having an agitating element was charged with 1,730 g of a silanol-terminated dimethylsiloxane represented by the formula (3) wherein m is 10 to 30 and 7 g of a vinyldimethylsilyl group-terminated polydimethylsiloxane having a viscosity of 60 cs, and heated to 105° C. over about one hour. After the temperature of 105° C. was reached, the reactor was held for one hour. Then, 2.8 g of a dimethylpolysiloxanate containing 10% tetra-n-butyl-phosphonium hydroxide as the thermally decomposable catalyst was added to the reactor, which was kept at the temperature of 105° C. and under a pressure of 50 mmHg for polymerization reaction to take place. After it was confirmed that the contents became polymerized to a high molecular weight, the pressure in the reactor was lowered below 3 mmHg, at which the reactor was held for 30 minutes. Thereafter, the reactor which was kept under a pressure of 100 mmHg was heated to 150° C. over about one hour and held at 150-160° C. for 30 minutes to thermally decompose the tetra-n-butylphosphonium hydroxide. Thereafter, with the pressure in the reactor lowered below 3 mmHg, a low volatile fraction was distilled off over about one hour.

During the process, the viscosity increased with the passage of polymerization time. The organopolysiloxane obtained after two hours of polymerization was a colorless clear gum-like product having an average degree of polymerization of more than 5,000 (as analyzed by GPC).

In 90 g of toluene was dissolved 10 g of the organopolysiloxane thus obtained. The viscosity at 25° C. of this toluene solution was measured (Viscosity 1). With stirring, 0.5 g of tetramethoxysilane and 4 droplets of tetrapropyl titanate were added to the toluene solution. The solution was allowed to stand for one hour before its viscosity was measured again (Viscosity 2). A relative viscosity given by Viscosity 2/Viscosity 1 was 1.00. A relative viscosity of approximately 1 indicates that the viscosity remained unchanged because few hydroxyl groups were present in the organopolysiloxane and condensation reaction did not take place between methoxy groups on the tetramethoxysilane and hydroxyl groups.

### Example 4

A 4-liter stainless steel reactor as used in Example 3 was charged with 1,730 g of a mixture of a silanol-terminated dimethylsiloxane represented by the formula (3) wherein m is 10 to 30 and a cyclic organosiloxane represented by the formula (5):

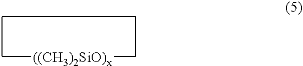

wherein x is 3 to 6 in a weight ratio of 65:35, and 7 g of a vinyldimethylsilyl group-terminated polydimethylsiloxane having a viscosity of 60 cs, and heated to 105° C. over about one hour. After the temperature of 105° C. was reached, the reactor was held for one hour. Then, 2.8 g of a dimethylpolysiloxanate containing 10% tetra-n-butyl-phosphonium hydroxide as the thermally decomposable catalyst was added to the reactor, which was kept at the temperature of 105° C. and under a pressure of 50 mmHg for polymerization reaction to take place. After it was confirmed that the contents became polymerized to a high molecular weight, the pressure in the reactor was lowered below 3 mmHg, at which the reactor was held for 30 minutes. Thereafter, the reactor which was kept under a pressure of 100 mmHg was heated to 150° C. over about one hour and held at 150-160° C. for 30 minutes to thermally decompose the tetra-n-butylphosphonium hydroxide. Thereafter, with the pressure in the reactor lowered below 3 mmHg, a low volatile fraction was distilled off over about one hour.

As in Example 3, the organopolysiloxane obtained was a colorless clear gum-like product having an average degree of polymerization of more than 5,000 (as analyzed by GPC).

The viscosity was similarly measured to give a relative viscosity of 1.00, confirming that few hydroxyl groups were present in the organopolysiloxane.

### Example 5

A polymerization run was carried out as in Example 3 except that the thermally decomposable catalyst was 0.71 g of a 40% aqueous solution of tetra-n-butylphosphonium hydroxide.

As in Example 3, the organopolysiloxane obtained was a colorless clear gum-like product having an average degree of polymerization of more than 5,000.

The viscosity was similarly measured to give a relative viscosity of 1.00, confirming that few hydroxyl groups were present in the organopolysiloxane.

### Example 6

A polymerization run was carried out as in Example 4 except that the thermally decomposable catalyst was 0.62 g of a 15% aqueous solution of tetramethylammonium hydroxide.

As in Example 4, the organopolysiloxane obtained was a colorless clear gum-like product having an average degree of polymerization of more than 5,000.

The viscosity was similarly measured to give a relative viscosity of 1.01, confirming that few hydroxyl groups were present in the organopolysiloxane.

### Example 7

A polymerization run was carried out as in Example 3 except that the end-capping agent was 70 g of a vinyldimethylsilyl group-terminated polydimethylsiloxane having a viscosity of 1,000 cs.

During the process, the viscosity increased with the passage of polymerization time. As in Example 3, the organopolysiloxane obtained after 2 hours of polymerization was a colorless clear gum-like product having an average degree of polymerization of more than 5,000 (as analyzed by GPC).

The viscosity was similarly measured to give a relative viscosity of 1.00, confirming that few hydroxyl groups were present in the organopolysiloxane.

### Comparative Example 2

A polymerization run was carried out as in Example 3 except that polymerization reaction was effected under atmospheric pressure.

The organopolysiloxane obtained was a colorless clear gum-like product having an average degree of polymerization of more than 5,000, as in Example 3.

The viscosity was similarly measured to give a relative viscosity of 1.30, indicating that formation of hydroxyl groups in the organopolysiloxane was not prohibited. When this organopolysiloxane is compounded with a reinforcement such as silica to formulate a silicone rubber composition, a crepe hardening phenomenon will occur in the composition.

In the method of the invention, an organopolysiloxane can be prepared from a silanol-terminated siloxane as the main reactant through a simple step and without the risk of equipment corrosion. In the second embodiment, an organopolysiloxane substantially devoid of hydroxyl groups in terminal units can be prepared. By compounding the latter organopolysiloxane with a reinforcement like silica, a silicone rubber composition of quality which gives rise to little or no crepe hardening phenomenon is manufactured in an industrially advantageous manner.

Japanese Patent Application Nos. 2002-161377 and 2002-161380 are incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method for preparing an organopolysiloxane terminated with silanol at both ends, comprising the step of polymerizing a siloxane having silanol at both ends in the presence of a thermally decomposable polymerization catalyst, the polymerization reaction being effected under a reduced pressure below atmospheric pressure.

2. The method of claim 1 wherein the polymerization reaction is effected under a reduced pressure of up to 100 mmHg.

3. The method of claim 1 wherein the polymerization catalyst is selected from the group consisting of tetra-n-butylphosphonium hydroxide, tetramethylammonium hydroxide and dimethylpolysiloxanates thereof.

4. A method for preparing an organopolysiloxane, comprising the step of polymerizing a siloxane having silanol at both ends with a triorganosilyl end-capped linear organosiloxane in the presence of a thermally decomposable polymerization catalyst under a reduced pressure below atmospheric pressure to produce a triorganosilyl group end-capped organopolysiloxane.

5. The method of claim 4 wherein the polymerization reaction is effected under a reduced pressure of up to 100 mmHg.

6. The method of claim 4 wherein the polymerization catalyst is selected from the group consisting of tetra-n-butylphosphonium hydroxide, tetramethylammonium hydroxide and dimethylpolysiloxanates thereof.

7. The method of claim 4 wherein the organopolysiloxane produced is gum-like.

8. The method of claim 4 wherein the organopolysiloxane produced has a relative viscosity of up to 1.05.
